(19) United States
(12) Patent Application Publication
(10) Pub. No.: US 2003/0149658 A1
(43) Pub. Date: Aug. 7, 2003

(54) System for providing a warranty for the automated valuation of property

(75) Inventors: Doug Rossbach, Rumson, NJ (US); Dennis Conway, Houston, TX (US)

Correspondence Address: SCHNADER HARRISON SEGAL & LEWIS, LLP, 1600 MARKET STREET, SUITE 3600, PHILADELPHIA, PA, 19103

(73) Assignee: RADIAN GROUP, INC., PHILADELPHIA, PA (US)

(21) Appl. No.: 10/355,597

(22) Filed: Jan. 31, 2003

Related U.S. Application Data
(60) Provisional application No. 60/354,885, filed on Feb. 6, 2002.

(51) Int. Cl. G06F 17/60

(52) U.S. Cl. 705/38

(57) ABSTRACT

The invention is directed to a method and apparatus for protecting a party having an interest in a real property against an inaccurate appraisal of the value of the real property, wherein a loan is provided from a lender to a borrowed, the loan being secured by the real property wherein the system involves generating a determined value of the real property using an automated valuation model; and covering the lender under a warranty for a warranted amount comprising at least a portion of the determined value to provide financial compensation for at least a portion of the appraised in value of the real property. The system of the invention may be accomplished over a computer network, such as by using email and the Internet.

### BACKGROUND

The field of the invention is systems for providing a warranty for the automated valuation of a property. Particularly, the field of the invention is methods and apparatus for determining the value of a real property and providing a warranty for that valuation process, where the warranted value is calculated through the use of an automated valuation system.

In loan transactions for the financing or refinancing of real property or obtaining a second mortgage thereon, borrowers are often surprised at the high closing costs associated with completing the transaction. In order to obtain the loan from a lender, the borrower is often times required by the lender to obtain and pay for a number of items. Moreover, the complexity of the transaction often limits the manner and location in which settlement may occur, and greatly increases the cost of the transaction.

One of the most important components of the mortgage process is the appraisal. The goal, at origination or at the secondary market level, is to have proof of the value and condition of the property that will support the loan secured by the property. This appraisal is typically required by lenders in an effort to protect their security interest in the loan and is usually paid for by the borrower at, or prior to, closing.

However, there are times when a traditional appraisal is not required to satisfy a loan value for an equity, refinancing, second mortgage or home improvement loan, and the cost of the traditional appraisal adds unnecessarily to the closing costs of the transaction. Accordingly, a system is needed that will fulfill the lender's need for a property valuation, but will help to reduce the time and expense of a traditional appraisal.

### SUMMARY OF THE INVENTION

Embodiments of the invention include a system for providing a party with a warranty on the valuation of a property, typically a home or other real property. The value of the property is calculated through the use of an automated valuation system. This calculation is preferably accomplished using comparable properties, tax information and artificial intelligence.

The party is protected during the provision of a loan to a borrower, wherein the loan is to be secured by a real property, against an inaccurate appraisal of the value of the real property. Embodiments of the invention are preferably used to generate a determined value of the real property using an automated valuation model; and cover the party under a warranty for a warranted amount comprising at least a portion of the determined value to provide financial compensation for at least a portion of the appraisal value of the real property. The system of the invention may be accomplished over a computer network, such as by using email and the Internet.

### BRIEF DESCRIPTION OF THE DRAWINGS

FIG. 1 is a block diagram illustrating a preferred embodiment of the invention used over the Internet.

FIG. 2 is a computer screen shot of a login screen in accordance with aspects of the invention.

FIG. 3 is a computer screen shot of a current order form in accordance with aspects of the invention

FIGS. 4(a)-(c) are computer screen shots of an order submission form in accordance with aspects of the invention.

FIGS. 5(a)-(b) are computer screen shots of an order details form in accordance with aspects of the invention.

FIG. 6 is a computer screen shot of an order status form in accordance with aspects of the invention.

FIG. 7 is a computer screen shot of a documents form in accordance with aspects of the invention.

FIG. 8 is a computer screen shot illustrating an order form application in accordance with aspects of the invention.

FIG. 9 is a computer screen shot illustrating an order confirmation form in accordance with aspects of the invention.

FIG. 10 is a computer screen shot illustrating an online warranty certificate in accordance with aspects of the invention.

### DETAILED DESCRIPTION

The present invention will be understood more fully from the detailed description given below and from the accompanying drawings of preferred embodiments of the invention; which, however, should not be taken to limit the invention to a specific embodiment but are for explanation and understanding only.

The terms “computer”, “computer system”, or “server” as used herein should be broadly construed to include any device capable of receiving, transmitting and/or using information including, without limitation, a processor, microprocessor or similar device, a personal computer, such as a laptop, palm PC, desktop, workstation, or word processor, a network server, a mainframe, an electronic wired or wireless device, such as for example, a telephone, an interactive television, such as for example, a television adapted to be connected to the Internet or an electronic device adapted for use with a television, a cellular telephone, a personal digital assistant, an electronic pager, a digital watch and the like. Further, a computer, computer system, or system of the invention may operate in communication with other systems over a communication network, such as, for example, the Internet, an intranet, or an extranet, or may operate as a stand-alone system.

The invention may be implemented through the use of a computer network, such as the Internet, and more particularly, the World Wide Web (the “Web”). While the invention disclosed herein depicts a preferred embodiment of the invention as deployed over the Internet using a Web browser, those of ordinary skill in the art will appreciate that the invention is not limited thereto and may be deployed using other means computer-based or otherwise, such as for example, thin client applications, and may be deployed over a closed network, Virtual Private Network, and any other securable internetworked system.

The Web allows users to interact with each other and access content through a graphical user interface, or “GUI.” The most commonly used GUI's are Web browsers, which are software applications that allow users to access and view electronic documents in a browser window. Web documents are created using Hypertext Markup Language (“HTML”), which allows authors to add special format tags to plain text documents to control the appearance of the text in the Web browser. HTML tags also allow for the insertion of additional components into the Web document, such as image files, audio files, and applets. Applets are small pieces of programming code that are run on the user's computer when downloaded. Applets allow for such effects as scrolling text and animation, and for use in the secure transfer of information across the Internet. To enhance security, an information server may use Secure Socket Layer (“SSL”) technology, which is widely known by those skilled in the art and is integrated into most commercially acceptable web browsers. One of ordinary skill in the art will appreciate that other, similar technology is also capable of being used in the invention, such as, for example, Visual Basic, Java/Java script, Active Server Pages (“ASP”), extensible Markup Language (“XML”), and Simple Object Access Protocol (“SOAP”).

The following is a description of the information collection and provisioning system aspect of the invention. In a preferred embodiment of the invention (although not limited thereto), information is submitted and provided over the Internet, such as through the use of a series of HTML forms, to and from an information server, which stores this information in a data source. The information to be transmitted, as described below, may be in the form of e-mail, Web pages, text files, or any other conventional electronic format capable of conveying information over a communication network. The operation of these media in transmitting information are well known to those of ordinary skill in the art, and will not be further elaborated upon here.

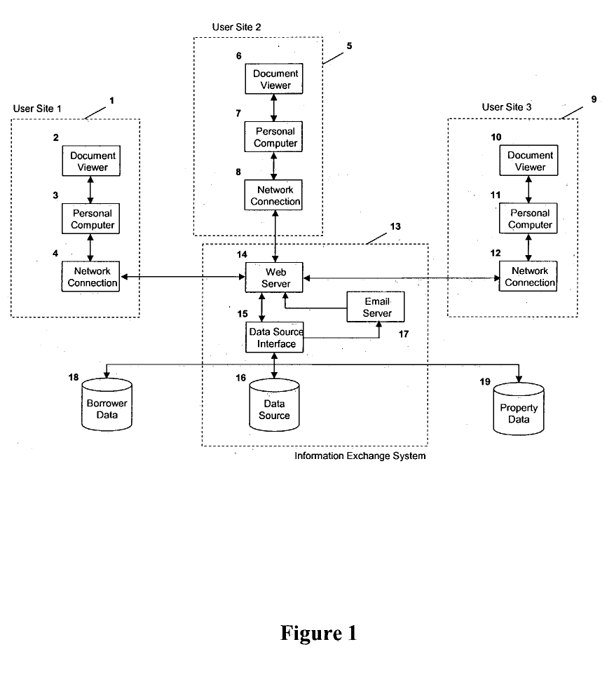

FIG. 1 is a simplified diagram demonstrating the typical components used in an embodiment when used over the Internet. In this example, there are a plurality of User Sites (1, 5, 9), which may be located, for example, at offices of a lender, or at a borrower's home or office. An electronic document, such as a Web page created using HTML and/or ASP, is loaded into a Document Viewer (2, 6, or 10) by a user. The document viewer may be any software application capable of viewing electronic documents and loading additional electronic documents from within the original document, such as through the use of a hypertext link (although not limited thereto). For example, the document viewer may include a Web browser, such as Navigator from Netscape Communications or Microsoft's Internet Explorer. The electronic document may be loaded automatically when the document viewer is first started, or may be opened into the viewer by the user from a file stored locally or at a remote URL. For example, the user may load the document by typing the document's URL into the Web browser's command line.

Document Viewer (2, 6, or 10) may be accessed by the user through any of a number of computer systems, such as through the use of a terminal connected to a mainframe system, from a personal computer, or over a computer connected to a local computer network or the like.

Document Viewer (2, 6, or 10) is connected to the Internet along with other document viewers and computers, such as Personal Computer (3, 7, or 11) through Network Connection (4, 8, or 12). This connection is typically made through local telephone lines using an analog, ISDN, or DSL modem, although it can be over a direct network connection, such as an Ethernet network, for example. The administrator of the network connection (e.g. an Internet Service Provider or “ISP”) maintains a computer network that routes requests from the document viewer to the appropriate location on the Internet, for example. This is accomplished in a conventional manner, such as through the use of a modem pool connected to a local server and Internet gateway (not shown). Information is transmitted over the Internet using the TCP/IP protocol. With this protocol, each location on the Internet, typically a specific computer or Web server, has its own unique IP (Internet Protocol) address. This address identifies where the computer or server is located on the network. The network connects the document viewer to Information Exchange System 13 through any of a number of well-known connection schemes, such as through the use of leased lines. Information Exchange System 13 may comprise Web Server 14, Data Source Interface 15, Data Source 16, and Email Server 17, the operation and interrelation of which is described in more detail below.

After a Web document is loaded into the document viewer, the document viewer waits until the hypertext link is activated, generating a signal to Web Server 14 in Information Exchange System 13. This is preferably in the form of an HTTP request sent over the Internet using TCP/IP and SSL. The HTTP request may include a request for stored information, a submission of information, or both. It will be appreciated that the details of HTTP operation in conjunction with TCP/IP are well known to those of ordinary skill in the art and will, therefore, not be elaborated on here.

Web Server 14 may be a software application running on a remote computer that is capable of forwarding or processing HTTP requests from each document viewer. For example, Web Server 14 may include any one of a number of well-known server applications, such as any NSCA based Web server, the Apache Web server, or the like. When the HTTP request is received by Web Server 14, Web Server 14 accesses Data Source 16 using Data Source Interface 15 to retrieve any requested information, or to submit information, based upon signal from the document viewer. In one embodiment of the invention, Web Server 14 receives the HTTP request from Document Viewer (2, 6, 10), parsing the request to determine the desired information.

The requested information is preferably accessed in Data Source 16 by using a common gateway interface (“CGI”), well known to those of skill in the art, as Data Interface 15. This program acts as an interface between the server and the data source by executing a set of instructions based upon the information received by the server in the HTTP request and passed by the server to the CGI program. The CGI program can take a number of forms which are well known in the art, such as PERL scripting, C++ modules, Visual Basic or other common programming languages. It may also comprise, for example, an Application Program Interface (“API”) or a suite of database tools or objects associated with Data Source 16.

The CGI program may extract the document location information, e.g. the URL, from the information passed to it by Web Server 14 and retrieve a record or records from Data Source 16. Conversely, it may also submit information as well. This may be accomplished in a number of ways. For example, if the CGI program is a PERL script, a database access module, can be used in connection with a number of database packages, such as to interface with the majority of commercial relational database applications, which may comprise Data Source 16. Examples of such databases include Oracle, Sybase, SQL Server, Microsoft Access, and the like. The interaction of Web servers, CGI programs, and data sources and the sending of information there between is well known to those of ordinary skill in the art.

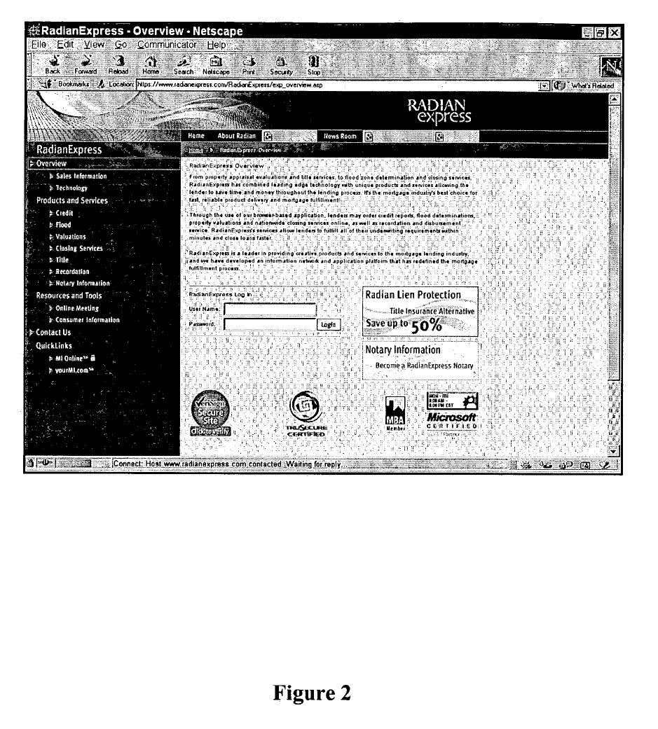

The operation of the system is further illustrated in FIGS. 2-6. FIG. 2 is a computer screen shot of a sample login screen for a Web site of the system. In order to access Information Exchange System 13, the lender or borrower preferably has an account on the system, which is protected by a user name and password in a conventional manner.

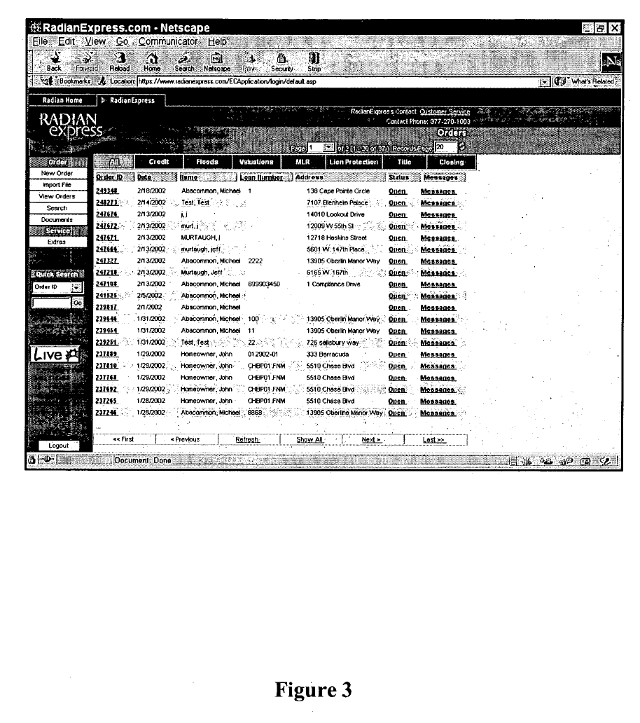

After supplying the proper user name and password, a user, such as a lender, logs into Information Exchange System 13, where the current order form is provided, an example of which is shown in FIG. 3. The current order form preferably contains a listing of information on current orders that are stored in Data Source 16 of Information Exchange Server 13 and retrieved there from by Data Interface 15, and served to the user by Web Server 14 in a conventional manner. Orders are preferably assigned an Order ID by which they can be uniquely identified and tracked in the system. The date of origination for the order is preferably provided, as well as the name of the borrower, the loan number, the borrower's address, and the status of the order. In this example, a link is also provided to any messages that have been sent between the lender and the insurer and vice versa. Navigational icons may also be provided, as shown.

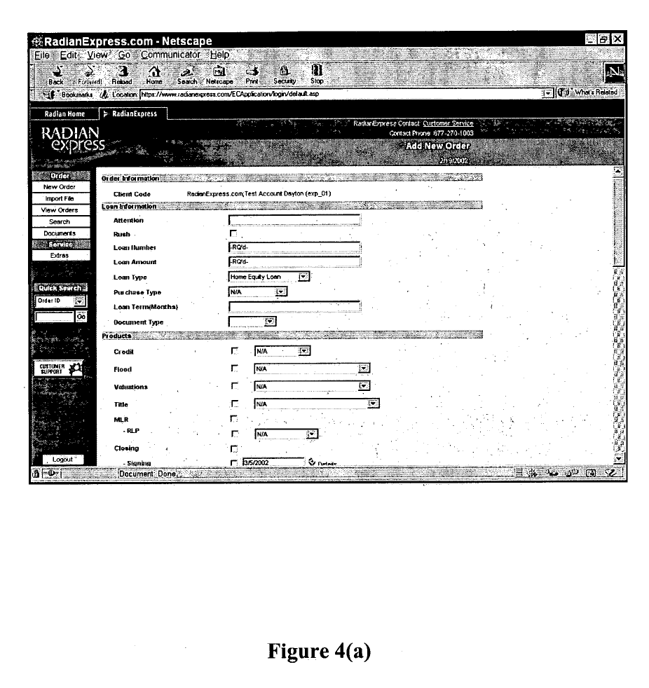

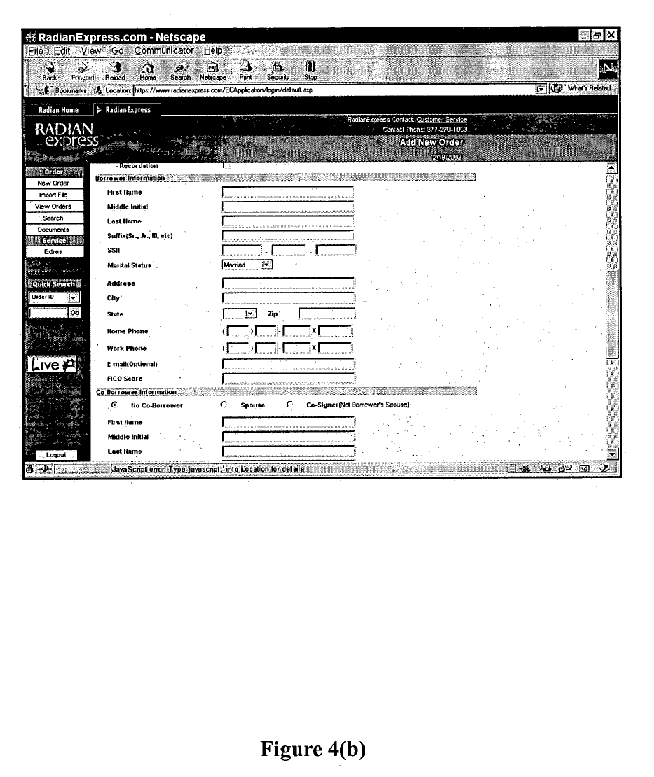

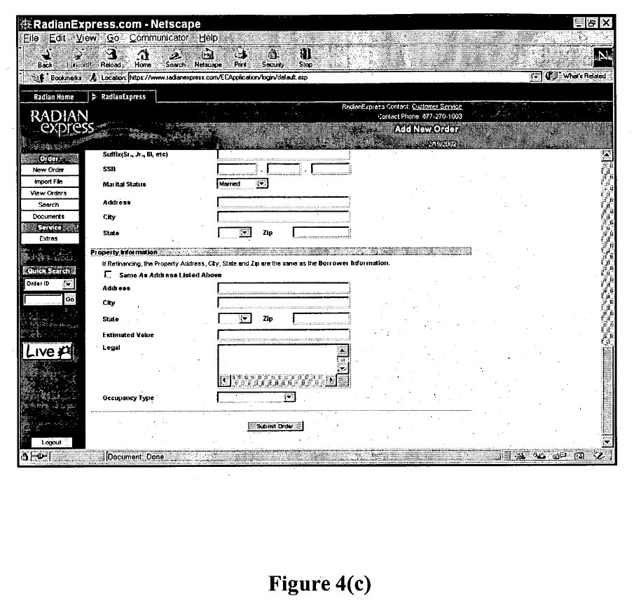

To submit a new order for loan related information, the user preferably clicks on the new order icon. This retrieves a general order submission form, an example of which is shown in FIGS. 4(a)-(c). As shown in FIGS. 4(a)-(c), the user is prompted to provide loan related information, such as the loan number, the loan amount, the loan type (e.g., rate/term refinance, cash-out refinance, home equity loan, or home equity line of credit—HELOC), the purchase type (e.g., conventional, FHA, or VA), the term of the loan, and the documentation required for the loan (e.g., full or partial). The user is also prompted to select the products to be ordered, which may include a mortgage lien report and mortgage guaranty insurance, an appraisal/valuation, credit search, flood report, title search, title recordation, and the like. Borrower information may also be requested, for example, the borrower's name, address and social security number. Finally, information on the property is requested, such as the address, estimated value, and occupancy type (e.g., primary residence, secondary residence, or investment property).

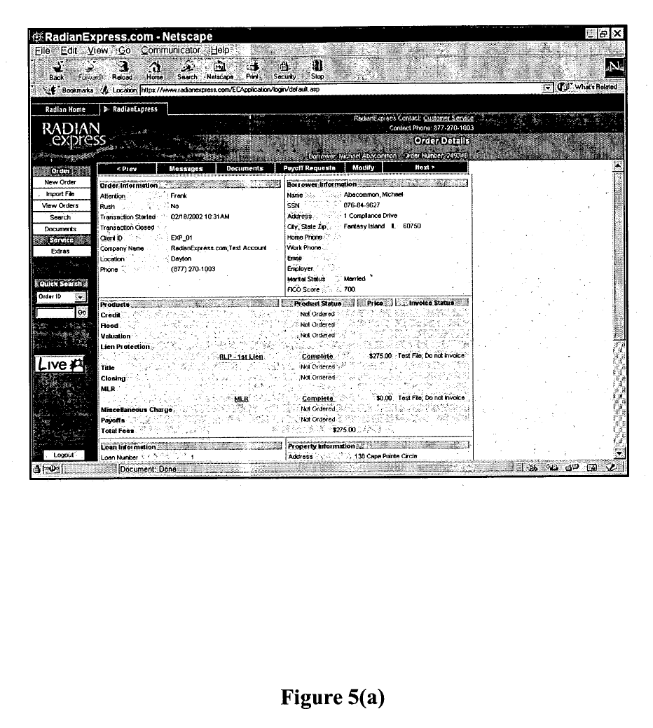

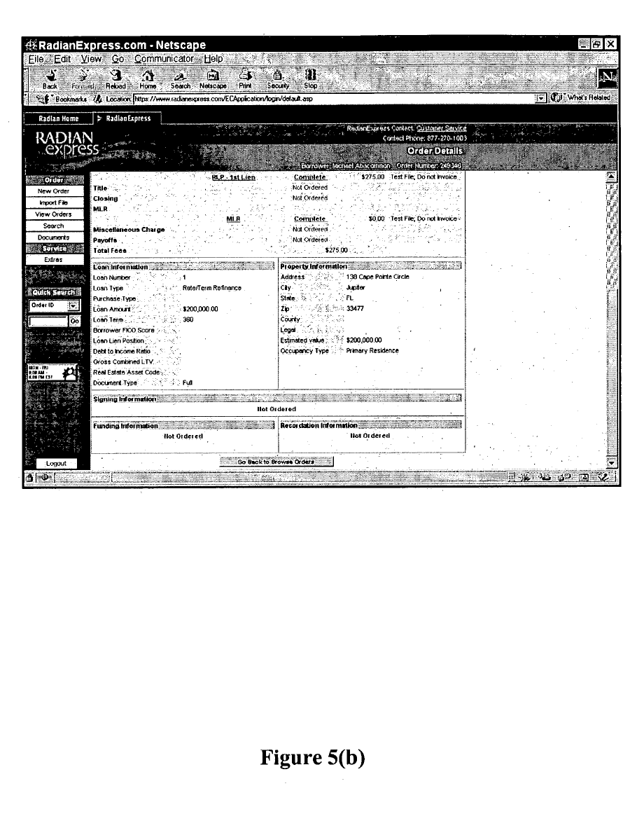

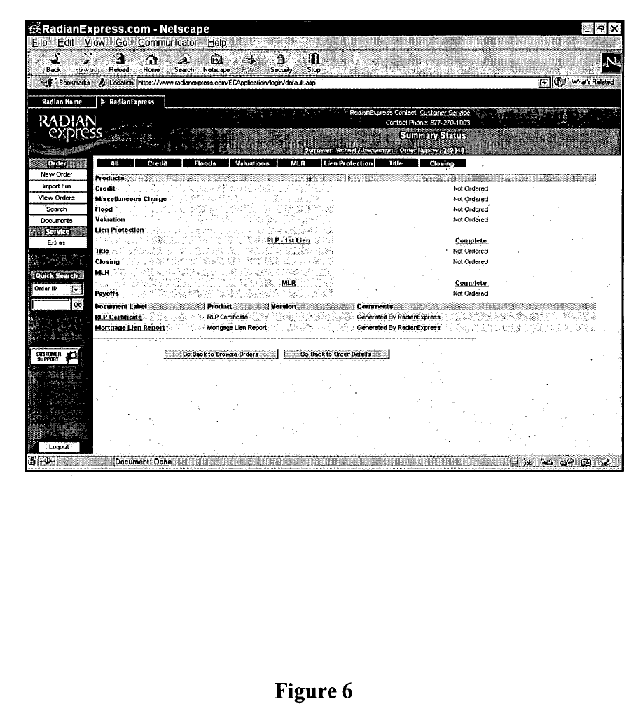

The order is then submitted, preferably by clicking on the Submit Order button. Thereafter, details of the order may be retrieved from Information Exchange System 13 in any number of ways, such as by clicking on the order ID on the current order form, or clicking the View Orders icon and selecting a particular order. This retrieves an order details form, such as the example shown in FIGS. 5(a)-(b). The order details form contains pertinent information about the order that was submitted via the order submission form previously described. Similarly, FIG. 6 shows an order status form that provides the lender and the borrower with information on the status of the production of the documents requested in the order.

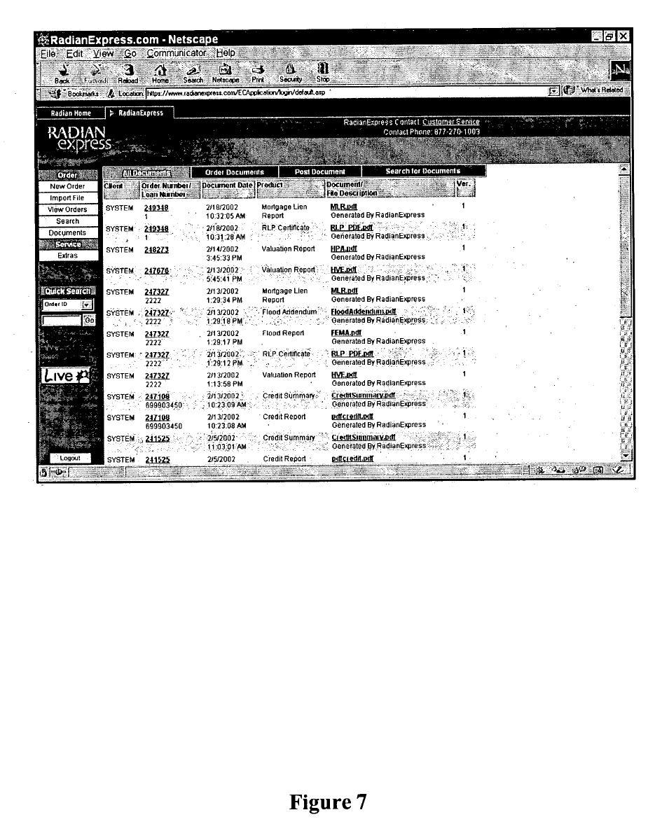

As noted above, the user may order a variety of documents using the order submission form. Once these documents are complete, they may be downloaded from Information Exchange System 13 in a conventional manner, such as a file in .PDF format (although not limited thereto). FIG. 7 illustrates a documents form listing the various documents that have been selected for each order. This form may be accessed, for example, by clicking on the Documents icon on the menu bar. A particular document for an order may be downloaded simply by clicking on the appropriate link on the documents form.

In a preferred embodiment, the documents are prepared automatically and in real time by Information Exchange System 13. However, they may also be completed off-line. For example, once the loan related information has been submitted to Information Exchange System 13 by the lender using the order submission form, this information is preferably stored in Data Source 16. A software process operating on Web Server 14 in conjunction with Data Interface 15 in this embodiment then accesses this information and retrieves the desired information from Borrower Data Source 18 and Property Data Source 19. The retrieved information may then be stored in Data Source 16 as associated with the order ID for that order. When the user clicks on the link to retrieve a report, the Data Interface 15 retrieves the information from Data Source 16 and produces the report, which is returned to the user via Web Server 14. All of this can be accomplished using the aforementioned software programming in a conventional manner well known to those of ordinary skill in the art.

The above-described system may be used in the invention, for example, to provide information related to one or more warranted automated valuation models (“AVM”) that protects the lender or other servicer of a loan against a loss if the AVM value of the property as warranted at origination of the loan is determined to be materially greater than the actual value of the collateral, and the lender realizes a loss, such as through default or foreclosure. An AVM is an electronic (computerized) analysis of data from multiple sources of information about the property, such as public records, (e.g., records of current property owners, property tax records, property lien records, property judgment records, and property title records), multiple property listing services and other proprietary databases. AVMs utilize different methodologies when performing valuations, typically relying upon sales comparisons (hedonic) and repeat sales (statistical) approaches.

An AVM report will usually contain subject information, valuation information and sales comparables. For example, a typical AVM report might contain information on the current owner(s) of a property, its location and address, other lot related information (e.g., restrictions, covenants, etc.), property details (e.g., amenities, improvements, size, etc.), past sale data for the property, data on comparable sales of similar properties, neighborhood information, and any electronically obtainable information that may be used to evaluate the property and generate a determined value.

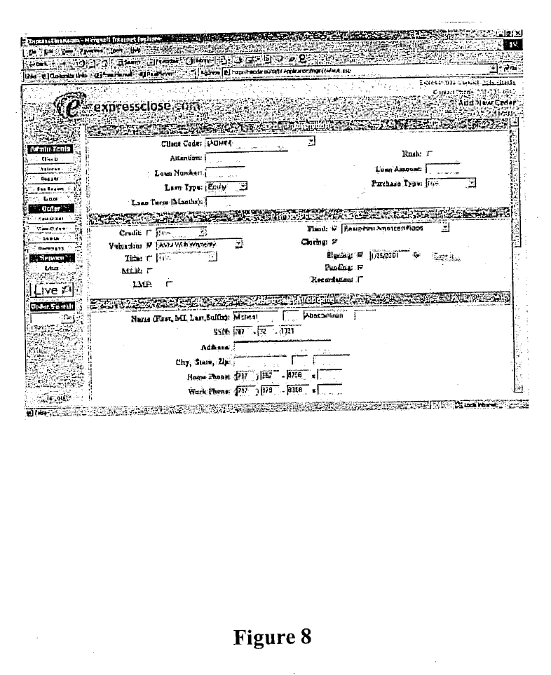

In order to obtain a warranted AVM, a lender may subscribe for warranted AVM service using Information Exchange System 13 in the manner described above. When the lender has received proper permission for the service, then the lender may place an order for a warranted AVM using the order submission system described above. An example of a Web page for submitting this order is shown in FIG. 8. As shown in FIG. 8, the lender may submit borrower information and may select the desired AVM and other products.

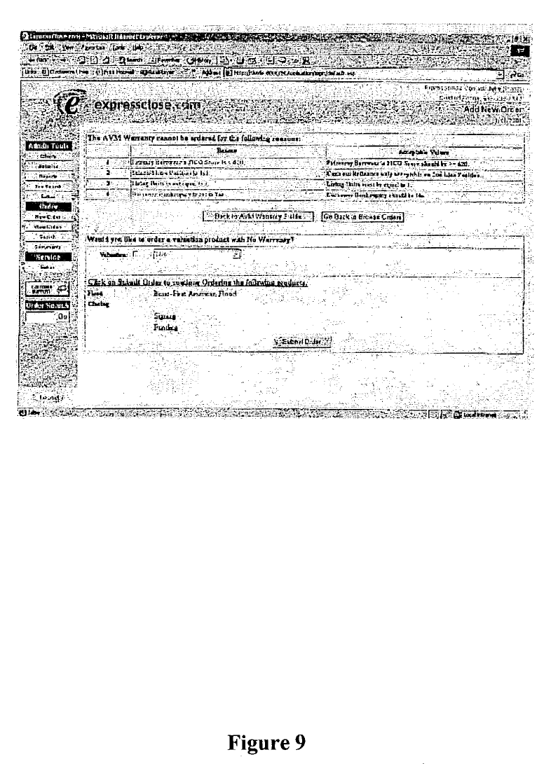

The system may then determine, based upon the information provided, whether the transaction qualifies for a warranty for the AVM. It may then return another order submission screen, which may include reasons for allowing or denying the warranty for the AVM. Some of the criteria that may be used for determining this are described in more detail below. An example of a Web page for this screen is shown in FIG. 9. In the screen shown in FIG. 9, the warranty has been denied for a variety of reasons listed therein. In this example, the lender then has the option of continuing the order for an AVM report without the warranty, and ordering any other products.

Once the AVM order is submitted, the system then calculates the value of the property using one of an AVM models (e.g., by using information from Borrower Data Source 18 and Property Data Source 19). Table 1 below provides a summary of several of the different AVM's that may be used in the system of the invention. It lists different AVM models, the company associated with each model, the label used by each model that indicates the most likely appraised value, and the label used by each model that indicates the upper range in value returned by each model, Different valuation models may be given a particular confidence level as indicated for each acceptable model. This confidence level is a statistically driven indicator of how confident the model is that the valuation returned is likely to be correct. The confidence factor is based on a number of factors such as availability of comparable sales data, and house characteristics. The confidence level may be used in determining whether and for how much a warranty may be granted, and what may be required for requesting payment under the warranty.

TABLE 1

| | | | | Confi- |
|---|---|---|---|---|
| | | Estimated | High | dence |
| AVM Name | Company Name | Valuation | Valuation | Level |
| Value Point | First American | Indicated | Maximum | ≧80 |
| | | Value | Adjusted | |
| | | | Sales Price | |
| Home Price | Mortgage Risk | Value | High | ≧80 |
| CASA | Case Shiller | Estimated | Estimated | A, B, C |
| | Weiss | Value | High Value | |
| Home Value | Data Quick | Estimated | Estimated | H, M |
| Explorer | | Market | High Value | |
| | | Value | | |
| PASS (Solimar) | Basis 100 | Value | Highest | ≧80 |
| | | | Reasonable | |

In the examples shown in Table 1, the numerical confidence values are percentages. The letter grades correspond to a range of predicted values, such as CASA® Confidence Grades, e.g., grade “A” has a predicted value range of within 6%, grade “B” has a predicted value range of 6% to 8%, and grade “C” has a predicted value range of 8% to 10% (where “predicted value range” is the predicted median absolute deviation of a CASA value estimate from the sale price). The letters “H” and “M” represent high and medium confidence, respectively.

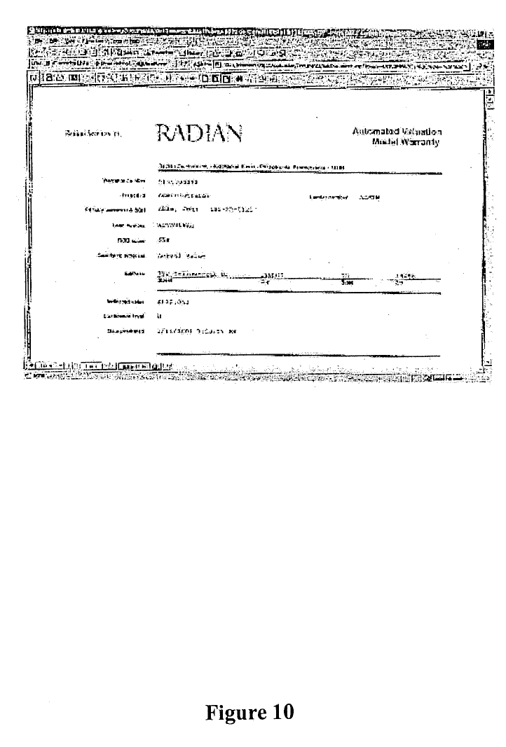

The system then generates a warranty certificate. The warranty may be returned as a Web page upon completion of the AVM, or, alternatively, the user may receive a notice to access the certificate online, such as through the use of the aforementioned .PDF files. The lender may also receive the certificate via email, such as through the use of Email Server 17. A sample warranty certificate is illustrated in FIG. 10. The warranty certificate preferably provides the details of a warranty agreement thus consummated between warranty issuer and the lender, as well as various identifying and factual information about the loan, property and borrower. This is described in more detail below.

The system of the invention is preferably used with transactions involving a first or second lien on a property, and having a determined maximum AVM appraised value of $650,000, although not limited thereto. The maximum warranted amount is preferably $50,000 if the primary borrower's Fair Isaac's Credit Score (FICO) is 680 and above, or $35,000 if the primary borrower's FICO Score is 620-679. The primary borrower FICO credit score used is preferably the middle of three scores, or the lower of two, if available. Borrowers preferably have not had a bankruptcy or foreclosure within the last seven years. The preferred maximum debt to income ratio for borrowers is 50%. Also, the transaction preferably has a maximum loan to value ratio limit of 95% for first liens and a maximum combined loan to value ratio of 100%. The loan to value ratio on a home equity line of credit (“HELOC”) is preferably calculated using the maximum credit line available.

Either full or alternative documentation is acceptable for use in the system of the invention and the warranted AVM of the invention may be made available on purchase or rate/term refinance transactions; and cash out refinance transactions are preferably only permitted with second liens.

The system of the invention is preferably used with the following types of properties: Single unit, attached or detached; Existing properties (no new construction); Primary residences and second homes. The system of the invention may also be used with following types of properties: Investment, Cooperatives, condominiums and manufactured housing. Manufactured housing are defined as manufactured/sectional homes, modular homes, and pre-fabricated homes.

A warranty provided on an AVM prepared in the manner of the invention preferably has a term of five (5) years. Coverage preferably automatically ceases upon any of the following events: five years from the date the warranted AVM is ordered; the loan is paid in full and/or refinanced; and/or the loan is assumed by another borrower. The warranted AVM may also preferably be transferred to another servicer without notice. Preferably, a single non-refundable fee is paid at closing.

The limit of a warranty given on an AVM in the system of the invention is preferably not affected by economic changes or changes in the condition of the property that occur after closing that might impact the value of the property; and is preferably calculated as the lesser of: (i) for the first lien mortgage loans, the net loss upon disposition of the property, (ii) for second lien mortgage loans, the write off loss of the second mortgage, (iii) the difference in the appraisals, or (iv) the maximum warranted amount.

Each warranty preferably covers only one loan. If coverage is desired on both a first and second lien, two warranties must preferably be purchased. If the subject loan has primary mortgage insurance for either the first or second mortgage, then the warranted AVM of the invention will preferably cover losses that are in excess of the mortgage insurance. The warranted AVM preferably is not payable in the event of fraud in any respect by any party.

Requests to amend the borrower and/or property information on the original warranty document may result in the need to furnish a new warranted AVM. This may result in an additional fee to the originating lender.

The payment request process may also be fully automated and accomplished online in a manner similar to the application process. For first lien loans, a request for payment on the warranty may preferably be made after a property is foreclosed, or after the property has been sold and a loss is realized. For second lien loans, a request for payment may preferably be made after the loan becomes 180 days delinquent and if the first lien has foreclosed the second lien or if the second lien is charged off and the note and lien are assigned to warranty issuer. If the warranted lender is a second lien holder who pays off the first lien, then the second lien holder becomes the first lien loan for claim eligibility purposes as described above.

In order to request a payment, a lender must preferably submit a notice of a valuation problem and submit a retrospective appraisal, prepared by an independent appraiser certified and licensed by the state where the property is located, evidencing the valuation inaccuracy as of the original closing/warranty date. (The “retrospective value” is an estimate of the market value of the property as of the warranted transaction date.) The lender must also preferably include a copy of the original borrower(s) credit report indicating the FICO score at closing. This may be accomplished, for example, using Information Exchange System 13 in the manner generally described above.

A second retrospective appraisal may also be prepared by an appraiser certified and licensed by the state where the property is located if a confirmation of retrospective value is needed. If the second retrospective appraisal is within 10% of the first appraisal, the average of the two retrospective appraisals are preferably indicated as retrospective value. If the first and second retrospective appraisals differ by more than 10% of the first retrospective appraisal value, then a third retrospective appraisal may be obtained and the average of the two appraisals closest together in value will be the indicated value. If the “retrospective value” is determined to be less than 90% of the original AVM, and a loss is realized by the warranted party, a payment should preferably be made.

Once the lender has reviewed the warranty certificate, any reports, and other appropriate documents, the lender approves or denies the loan application. This may also be accomplished using Information Exchange System 13, such as through email communication via Email Server 17, although not limited thereto. Using the system of the invention, the borrower has a simpler and less costly closing. The automated appraisal system of the invention has the significant advantage that it can be delivered to the lender or the borrower quickly (typically within ten seconds to 72 hours) at a greatly reduced cost as compared to the traditional appraisal.

Although this invention has been described with reference to particular embodiments, it will be appreciated that many variations may be resorted to without departing from the spirit and scope of this invention.

What is claimed is:

1. A method of protecting a party having an interest in a real property against an inaccurate appraisal of the value of said real property, wherein a loan is provided from a lender to a borrower, said loan being secured by said real property, said method comprising the steps of:
generating a determined value of said real property using an automated valuation model; and
covering said party under a warranty for a warranted amount comprising at least a portion of said determined value to provide financial compensation for at least a portion of said appraisal value of said real property.

2. The method of claim 1, wherein a loss due to said inaccurate appraisal arises from one or more selected from the group consisting of a default on said loan, a foreclosure on said property, damage to said property, destruction of said property, inability to use said property, and a drop in market value.

3. The method of claim 1, wherein said loan is selected from the group consisting of a rate/term refinance, a cash-out refinance, a home equity loan, or a home equity line of credit.

4. The method of claim 1, wherein said automated valuation model uses property related information comprising one or more selected from the group consisting of a record of current property owners, property tax records, property lien records, property judgment records, property title records, multiple property listing services, property location and address, lot related information, past sale data for said property, data on comparable sales of properties, and neighborhood information.

5. The method of claim 1, wherein said determined value is less than about $650,000.

6. The method of claim 1, wherein said warranted amount is no more than about $50,000 if said borrower has a FICO score of about 680 and above, and no more than $35,000 if said borrower has a FICO score between about 620-679.

7. The method of claim 1, wherein said borrower has a maximum debt to income ratio of about 50%.

8. The method of claim 1, wherein said warranty coverage is provided only if there is a maximum loan to value ratio limit of 95% for first liens and a maximum combined loan to value ratio of 100%.

9. The method of claim 1, wherein said property comprises one or more selected from the group consisting of a single unit, an attached unit, a detached unit, existing properties, primary residences, and second homes.

10. The method of claim 1, wherein said warranty has a term of five (5) years.

11. The method of claim 1, wherein said warranty coverage automatically ceases upon one or more of the events selected from the group consisting of completion of five years from the date said warranty is provided, said loan is paid in full, said loan is refinanced, and said loan is assumed by another borrower

12. The method of claim 1, wherein a maximum payment to be made under said warranty is calculated as the lesser of (i) for first lien mortgage loans, a net loss upon a disposition of said property, (ii) for second lien mortgage loans, a write off loss of said second lien mortgage, (iii) a difference between said determined value and another appraisal, or (iv) said warranted amount.

13. The method of claim 1, wherein a computer network is used for one or more selected from the group consisting of generating said determined value, coverage under said warranty, and a request for payment under said warranty.

14. The method of claim 1, wherein said loan is a first lien loan, and a request for payment on said warranty must be made after said property is foreclosed or after said property has been sold and a loss is realized.

15. The method of claim 1, wherein said loan is a second lien loan, and a request for payment must be made after said loan becomes 180 days delinquent and if a first lien has foreclosed said second lien, or if said second lien is charged off and a note and lien are assigned to an issuer of said warranty.

16. The method of claim 1, wherein a first retrospective appraisal of said property must be obtained as a retrospective value evidencing an inaccuracy in said determined value in order to request a payment.

17. The method of claim 16, wherein a second retrospective appraisal of said property must be obtained, and an average of said first and second retrospective appraisals is said retrospective value.

18. The method of claim 17, wherein a third retrospective appraisal of said property must be obtained and an average of a two of said appraisals closest in value is said retrospective value.

19. The method of claim 18, wherein if said retrospective value is less than 90% of said determined value and a loss is realized by said party, a payment should preferably be made.

20. A method of protecting a party having an interest in a real property against an inaccurate appraisal of the value of said real property, wherein a loan is provided from a lender to a borrower, said loan being secured by said real property, said method comprising the steps of:
receiving loan information on said loan;
generating a determined value of said real property using an automated valuation model;
wherein said automated valuation model includes property related information;
covering said party under a warranty for a warranted amount comprising at least a portion of said determined value to provide financial compensation for at least a portion of said appraisal value of said real property.

21. The method of claim 20, wherein said property related information includes one or more selected from the group consisting of a record of current property owners, property tax records, property lien records, property judgment records, property title records, multiple property listing services, property location and address, lot related information, past sale data for said property, data on comparable sales of properties, and neighborhood information.

22. The method of claim 20, wherein said steps of receiving said loan information, generating said determined value, and covering said party under said warranty are accomplished using a computer network.

23. A system for protecting a party having an interest in a real property against an inaccurate appraisal of the value of said real property, wherein a loan is provided from a lender to a borrower, said loan being secured by said real property, said system comprising a data interface programmed to cover said party under a warranty for a warranted amount comprising at least a portion of a determined value generated using an automated valuation model to provide financial compensation for at least a portion of said appraisal value of said real property.

24. The system of claim 23, further comprising a data source, wherein said data interface is further programmed to store information in said data source on one or more selected from the group consisting of said property, said warranty, said determined value, said valuation model, said loan, said borrower, said lender and said party.

25. The system of claim 23, wherein said automated valuation model uses property related data that includes one or more selected from the group consisting of a record of current property owners, property tax records, property lien records, property judgment records, property title records, multiple property listing services, property location and address, lot related information, past sale data for said property, data on comparable sales of properties, and neighborhood information.

26. The system of claim 23, wherein said data interface further comprises one or more user interfaces selected from the group consisting of a Web server, an email server, a server application operating in a client/server architecture, and telephonic equipment operating over telephone lines.

27. The system of claim 23, wherein said data interface comprises one or more selected from the group consisting of a common gateway interface, an application program interface, database applications tools, and database application objects.

28. The system of claim 24, wherein said data source comprises a relational database.

29. A computer program embodied in a machine readable device for communicating information to and from a user in connection with a loan for a real property to be made by a lender to a borrower, said computer program comprising:
a user interface programmed to 1) transmit loan information on said loan; 2) request a determined value of said real property using an automated valuation model; and 3) request a warranty for a warranted amount comprising at least a portion of said determined value to provide financial compensation for at least a portion of said determined value of said real property.

30. The computer program of claim 29, wherein said user interface is further programmed to request said determined value and information on said automated valuation model.

31. The computer program of claim 29, wherein said user interface comprises one or more selected from the group consisting of a Web browser, an email client, a client application operating in a client/server architecture, and telephonic equipment operating over telephone lines.
